(19) United States
(12) Patent Application Publication
(10) Pub. No.: US 2008/0178273 A1
(43) Pub. Date: Jul. 24, 2008

(54) Automated Authentication Process for Application Clients

(76) Inventor: Elmar Weber, Petershagen (DE)

Correspondence Address: FENWICK & WEST LLP, SILICON VALLEY CENTER, 801 CALIFORNIA STREET, MOUNTAIN VIEW, CA, 94041, US

(21) Appl. No.: 12/018,767

(22) Filed: Jan. 23, 2008

Related U.S. Application Data
(60) Provisional application No. 60/886,243, filed on Jan. 23, 2007.

(51) Int. Cl. H04L 9/08; H04L 9/32

(52) U.S. Cl. 726/7; 380/278

(57) ABSTRACT

One aspect of the invention defines a process which allows application providers to remotely activate and authenticate logins from an application client. In one implementation, this is achieved through a three step approach. First, the application client notifies the application service of its successful installation (e.g. by accessing a unique URL). Second, it leverages the built-in security features of a mobile network (e.g. security mechanisms of GSM or IMS access security) to securely deliver a message containing authentication information to the application client. Examples of message transports are SMS or SIP with IPsec as specified by IMS. Third, this information is used to authenticate the application client when accessing the remote application service (e.g. via the Internet).

### CROSS-REFERENCE TO RELATED APPLICATION(S)

This application claims priority under 35 U.S.C. §119(e) to U.S. Provisional Patent Application Ser. No. 60/886,243, “Automated Authentication Process for Application Clients,” filed Jan. 23, 2007. The subject matter of the foregoing is incorporated herein by reference in its entirety.

### BACKGROUND OF THE INVENTION

1. Field of the Invention

This invention relates generally to the authentication of an application client towards a remote application service, where the application client has been installed on a mobile communications device.

2. Description of the Related Art

Web site operators sometimes deliver login and password information over SMS requiring the user to manually enter these credentials.

Web site operators frequently use temporary links (URLs) delivered via e-mail as a means of validating a user's identity prior to activating a new user account.

Secure data connections including both server and optionally client authentication using certificates as well as encrypted transmission are readily supported by SSL, TLS, HTTPS and other Internet protocols. However, mobile communications devices frequently do not have client certificates installed. Additionally, issuing and managing client certificates require a complex and costly infrastructure. There is a need for client authentication which does not rely on client certificates.

Liberty alliance provides a mechanism to authenticate via a trusted network of service providers. However, this does not address the issue of the initial login and does not fully leverage the authentication mechanism of the mobile network.

### SUMMARY OF THE INVENTION

One aspect of the invention defines a process which allows application providers to remotely activate and authenticate logins from an application client without requiring the user to manually enter any login or password information, or to manually respond to a message, or to manually launch a browser. In one implementation, this is achieved through a three step approach. First, the application client notifies the application service of its successful installation (e.g. by accessing a unique URL). Second, it leverages the built-in security features of a mobile network (e.g. security mechanisms of GSM or IMS access security) to securely deliver a message containing authentication information to the application client. Examples of message transports are SMS or SIP with IPsec as specified by IMS. Third, this information is used to authenticate the application client when accessing the remote application service (e.g. via the Internet). Additional, optional security mechanisms can be added to further harden the authentication process (e.g. integration with the AAA infrastructure of a network operator).

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1A shows an example of an automated client authentication process according to the invention.

FIG. 1B illustrates an example of an automated client login process following an authentication process as depicted in FIG. 1A.

### DETAILED DESCRIPTION OF THE PREFERRED EMBODIMENTS

The following terms and acronyms are used throughout this disclosure.

AAA server—Authentication Authorisation and Accounting infrastructure of a network operator. Typical examples are RADIUS and DIAMETER servers.

SMS-C/SMS-GW—Short Message Service—Center/Short Message Service—Gateway.

MNO—mobile network operator.

IMS—IP Multimedia Subsystem, for example as specified by 3GPP and/or 3GPP2.

Application client—An application which has been developed for a mobile device and which interacts with a remote server. Typical development platforms are Java/J2ME, Symbian/Series60/TUQ, Linux, BREW, Windows Mobile, .NET and others.

Communications address—a phone number, MSISDN, IMSI, SIP URI or other address used for communication purposes.

Key—unique identifier, typically containing randomly generated elements. It could also contain several elements such as a username and password.

Mobile transport network—a mobile network such as cellular networks using licensed spectrum radio network (e.g., GSM/GPRS/UMTS/CDMA/EVDO) or an unlicensed network (e.g., public internet access provided over WiFi).

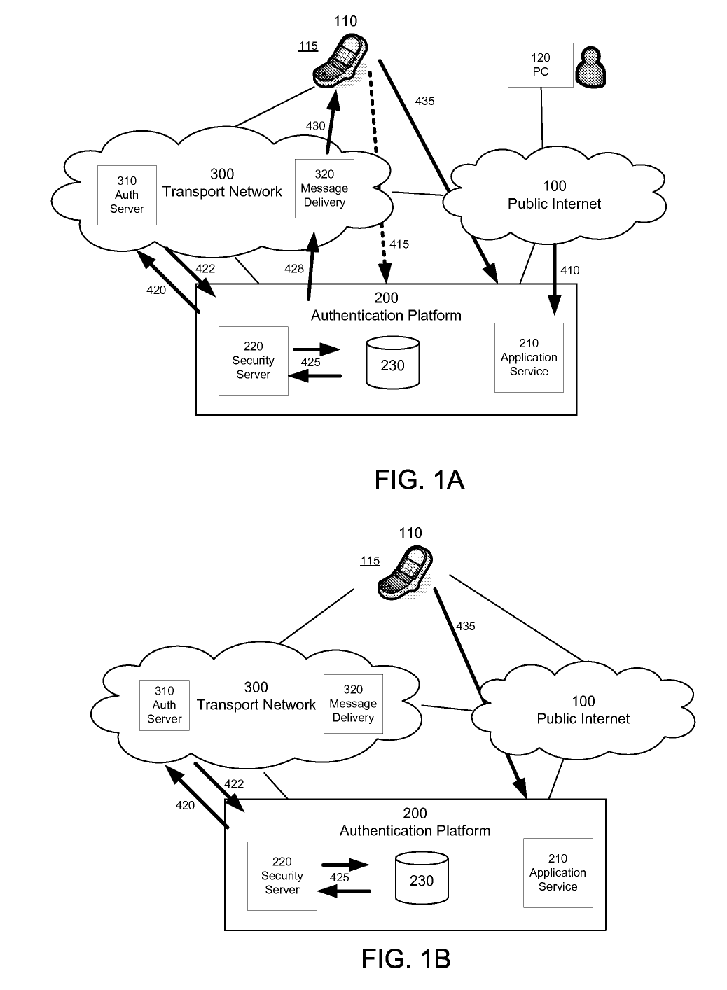

FIG. 1A shows an example of an automated client authentication process according to the invention. The invention can span multiple networks including public internet 100 and a mobile transport network 300.

The components in the diagram are as follows: the mobile device 110 contains an application client 115 requiring authentication to an application service 210, which stores the registration information for the user of the application client 115 and mobile device 110 in a secure registration database 230 or similar data storage mechanism.

The application service 210 may be loosely or tightly coupled with the authentication platform 200. In the tightly coupled case, the user has full access to the application service 210 immediately following the authentication process as described below. In the loosely coupled case, the security server 220 stores credentials required for the application service 210. These credentials may be provided by the user via a registration on a website.

The security server 220 is responsible for the security infrastructure and handshake between the application services 210 and the client device 110.

The transport network 300 contains several components used for the authentication process: a message delivery server 320 is used to reliably deliver a message to the client device 110 using the transport network 300. Typical examples of message delivery servers are: SMSC, SMS-Gateways, MMSC, e-Mail servers, SIP/IMS application servers and others. Note that there are varying degrees of security possible, depending on the message delivery server used for this invention. Using an email server for instance, in the internet example, is less secure than using the SMSC as the message delivery server in the GSM example.

The transport network 300 typically contains an authentication server 310 which is used to authenticate the client device 110 and to tie its communications address, which is typically but not always based on the IP address of the client device 110, to the user's registration information on the transport network. The security server 220 can access the authentication server 300 to validate the IP address of the client device 110 during the authentication process. Typically, but not always, the authentication server 300 is the AAA server of the transport network operator. In the GSM example, the authentication server 310 can provide the phone number of the mobile device 110 based on the IP address used by the mobile device 110.

FIG. 1A shows an efficient, automated client authentication and activation process according to the invention. It can be broken down into the following steps:
1. The end user registers 410 with the application service 210 over the public internet and provides his communications address. A typical example would be a registration via a web site from a PC 120 or a mobile device 110. The specific access mechanism can vary. The communications address provided is used to exchange security information with the client device and could be an email address, phone number, or SIP URI, among other things, depending on the characteristics of the transport network 300. The communications address provided by the user is stored in the registration database 230.
2. The end user downloads and installs the mobile application client 115.
3. The application client 115 registers for message notifications with the mobile device 110 (e.g. by registering to be notified when an SMS to a particular port is received).
4. In order to ensure that the application client has been installed successfully on the mobile device 110 prior to delivering the access key, the application client 115 notifies 415 the security server 220 that it has been installed successfully. The notification 415 can be sent immediately following the installation, at a later time, or when the application client 115 is launched for the first time by the user. The notification 415 can be delivered via the transport network 300 or the Public Internet 100 in a variety of ways, including but not limited HTTP, SMS, SIP, or a custom protocol over TCP/IP.
5. The security server 220 contacts 420 the authentication server 310 of the network operator to determine 422 the communications address of the mobile device 110. In the GSM example, the communications address (i.e. phone number) can be determined using the IP address of the mobile device 110. The security server 220 validates 425 that the communications address was registered in the registration database 230.
6. Following successful validation, the security server 220 generates a unique access key. Optionally the access key can have a defined expiry time and be superseded by a new key at a later time.
7. The access key is stored in the registration database 230 and is associated with the communications address 250 retrieved from the authentication server 310.
8. The security server 220 sends 428 the access key to the message delivery server 320. This exchange may happen through a direct interface to the message delivery server 320 or indirectly through a 3^{rd} party gateway or service which interfaces with the message delivery server 320 (e.g. an SMS gateway provider).
9. The message delivery server 320 delivers 430 the access key to the application client 115 using the key delivery message 430 (e.g. an SMS to a particular port).
10. The key delivery message 430 is automatically received by the application client 115 and stored in the mobile device 110.
11. The application client 115 is now activated and can use the access key to log into the security server 220 and access the application service 210.

FIG. 1B is an example of a login procedure following successful client authentication and activation as illustrated in FIG. 1A.
1. Application client 115 establishes a data connection 435 to the security server 220. Typically, but not always, this connection is secure TCP/IP connection (e.g. TCP/IP with SSL or HTTPS).
2. The application client 115 provides the access key to the security server 220 via the data connection 435.
3. The security server 220 validates 425 the unique access key against the registration database 230 to identify the user.
4. Optionally, for hardened security, the security server 220 contacts 420 the authentication server 310 to obtain 422 the communications address associated with the mobile device 110. The security server 220 validates 425 that the communications address was registered in the registration database 230 and corresponds to the same user that was identified in the previous step.
5. Following successful validation, the security server 220 grants the application client 115 access to the requested application service 210.
6. The application client 115 uses the data connection 435 to exchange data with the application service 210.
7. Optionally, in the case that the data connection 435 is encrypted, non-encrypted and thus faster connections can be established in addition (e.g. via HTTP, UDP, TCP). Temporary information identifying the session may be shared with the previously established encrypted data connection 435 in order to avoid multiple logins.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

What is claimed is:

1. A method for automated authentication of an application client on a mobile communications device comprising:
receiving a notification from a mobile communications device via a mobile transport network, the notification conditioned upon successful installation on the mobile communications device of an application client for an application service;
contacting an authentication server for the mobile transport network to determine a communications address of the mobile communications device;
validating the communications address in a registration database that contains registrations of communications addresses for the application service;
conditioned upon successful validation, storing a unique access key in the registration database in a manner that associates the unique access key with the communications address; and
sending the unique access key to a message delivery server for the mobile transport network, for delivery to the application client.

2. The method of claim 1 further comprising:
completing a login process for the application client to access the application service, the application client accessing the delivered unique access key as part of the login process.

3. The method of claim 2 wherein completing the login process comprises:
establishing a data connection with the application client;
receiving the unique access key from the application client via the data connection;
validating the unique access key in the registration database; and
conditioned upon successful validation, granting the application client access to the application service.

4. The method of claim 3 further comprising:
the application client and the application service using the data connection to exchange data.

5. The method of claim 3 wherein the data connection is an encrypted data connection.

6. The method of claim 3 wherein completing the login process further comprises:
contacting an authentication server for the mobile transport network to determine a communications address of the mobile communications device; and
validating the communications address in the registration database, the granting the application client access to the application service further conditioned upon successful validation of the communications address.

7. The method of claim 1 further comprising:
registering a communications address for the application service in the registration database.

8. The method of claim 1 wherein the notification is received via the mobile transport network using HTTP.

9. The method of claim 1 wherein the notification is received via the mobile transport network using SMS.

10. The method of claim 1 wherein the notification is received via the mobile transport network using SIP.

11. The method of claim 1 wherein the notification is received via the mobile transport network using a custom protocol over TCP/IP.

12. The method of claim 1 wherein the communications address comprises a phone number.

13. The method of claim 1 wherein the communications address comprises an email address.

14. The method of claim 1 wherein the communications address comprises a SIP URI.

15. The method of claim 1 wherein the communications address is determined using an IP address of the mobile communications device.

16. The method of claim 1 wherein the unique access key has a defined expiry time.

17. The method of claim 1 wherein the message delivery server comprises SMSC.

18. The method of claim 1 wherein the message delivery server comprises SMS-Gateway.

19. The method of claim 1 wherein the message delivery server comprises MMSC.

20. The method of claim 1 wherein the message delivery server comprises e-mail server.

21. The method of claim 1 wherein the message delivery server comprises SIP/IMS application server.

22. The method of claim 1 wherein sending the unique access key to a message delivery server comprises sending the unique access key directly to the message delivery server.

23. The method of claim 1 wherein sending the unique access key to a message delivery server comprises sending the unique access key indirectly to the message delivery server.

24. An authentication platform for automated authentication of an application client on a mobile communications device comprising:
a registration database that contains registrations of communications addresses for the application service; and
a security server in communication with the registration database, the security server performing the steps of:
receiving a notification from a mobile communications device via a mobile transport network, the notification conditioned upon successful installation on the mobile communications device of an application client for an application service;
contacting an authentication server for the mobile transport network to determine a communications address of the mobile communications device;
validating the communications address in a registration database;
conditioned upon successful validation, storing a unique access key in the registration database in a manner that associates the unique access key with the communications address; and
sending the unique access key to a message delivery server for the mobile transport network, for delivery to the application client.

25. The authentication platform of claim 24 wherein the security server further performs the step of:
completing a login process for the application client to access the application service, the application client accessing the delivered unique access key as part of the login process.

26. The authentication platform of claim 25 wherein the step of completing the login process comprises:
establishing a data connection with the application client;
receiving the unique access key from the application client via the data connection;
validating the unique access key in the registration database; and
conditioned upon successful validation, granting the application client access to the application service.

27. The authentication platform of claim 26 wherein completing the login process further comprises:
contacting an authentication server for the mobile transport network to determine a communications address of the mobile communications device; and
validating the communications address in the registration database, the granting the application client access to the application service further conditioned upon successful validation of the communications address.
